(19) United States
(12) Patent Application Publication
(10) Pub. No.: US 2014/0365602 A1
(43) Pub. Date: Dec. 11, 2014

(54) RECOMMENDING A MOBILE APPLICATION BASED ON ENVIRONMENTAL FACTORS

(71) Applicant: INTERNATIONAL BUSINESS MACHINES CORPORATION, Armonk, NY (US)

(72) Inventors: Matthew C. Hillary, Whitehouse, TX (US); Joshua D. Markwordt, Apex, NC (US); Michael M. Skeen, Raleigh, NC (US); Michael S. Thomason, Raleigh, NC (US)

(21) Appl. No.: 13/914,363

(22) Filed: Jun. 10, 2013

(51) Int. Cl. H04L 29/08

(52) U.S. Cl. CPC H04L 67/10
USPC 709/217

(57) ABSTRACT

A method for displaying an application for use on a mobile computing device. The method includes determining one or more environmental factors for a current environment of a mobile computing device. The method includes determining, based, at least in part, on the one or more environmental factors and past usage information of the mobile computing device, an application for use with the mobile computing device and displaying the application on the mobile computing device.

### FIELD OF THE INVENTION

The present invention relates generally to the field of mobile device applications, and more particularly to recommending a mobile application based on environmental factors.

### BACKGROUND OF THE INVENTION

A mobile application, or mobile app, is a software application designed to run on smart phones, tablet computers and other mobile devices. Mobile applications are typically available through application distribute platforms, such as the Apple App Store^{SM} or BlackBerry App World™. Some mobile applications are free to download, and others are available for purchase. Mobile applications are usually downloaded from the application distribution platform to a target mobile device, such as an iPad®, an iPhone® or a BlackBerry®, and can also be downloaded to laptop computers or tablet computers. Mobile applications are offered for information retrieval, for example, email, calendar, weather or news information, and, as a result of public demand, mobile applications are developed for a variety of other services, including mobile games, GPS, or banking.

Generally, in order for users to use the mobile application after downloading, the user must select the mobile application on a display screen of the mobile device. Mobile applications are normally arranged and illustrated in the form of a menu on the mobile device display screen for users' observation and selection. However, as the popularity of mobile applications continues to rise, a typical user has many mobile applications on a single mobile device. In order to activate a mobile application, the user is required to go through several menu displays before locating and activating a desired application.

### SUMMARY

Embodiments of the present invention disclose a method, computer program product, and computer system for displaying an application for use on a mobile computing device. The method includes determining, by one or more computer processors, one or more environmental factors for a current environment of a mobile computing device. The method includes determining, by the one or more computer processors, based, at least in part, on the one or more environmental factors and past usage information of the mobile computing device, an application for use with the mobile computing device and displaying the application on the mobile computing device.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a recommending program for collecting environmental and historical information for a mobile computing device and recommending an application based on the collected information, in accordance with an embodiment of the present invention.

FIG. 3 depicts a block diagram of components of a data processing system, such as the mobile computing device of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

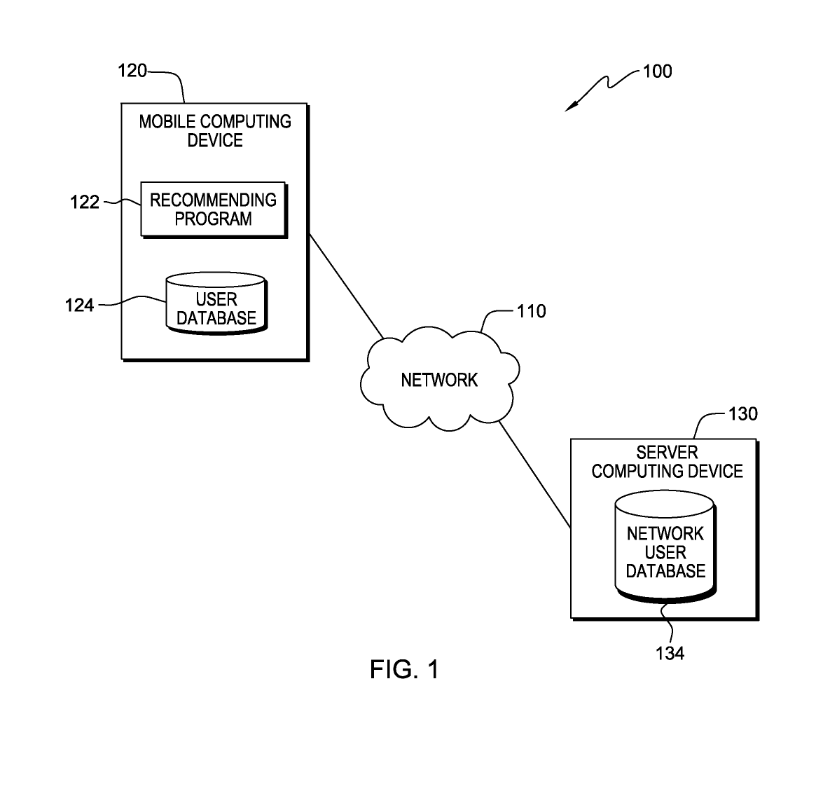

The present invention will now be described in detail with reference to the Figures. FIG. 1 is a functional block diagram illustrating a distributed data processing environment, generally designated 100, in accordance with one embodiment of the present invention.

Distributed data processing environment 100 includes mobile computing device 120 and server computing device 130, all interconnected over network 110. Network 110 can be, for example, a local area network (LAN), a wide area network (WAN) such as the Internet, a cellular network, or any combination of the preceding, and can include wired, wireless, or fiber optic connections. In general, network 110 can be any combination of connections and protocols that will support communications between mobile computing device 120 and server computing device 130.

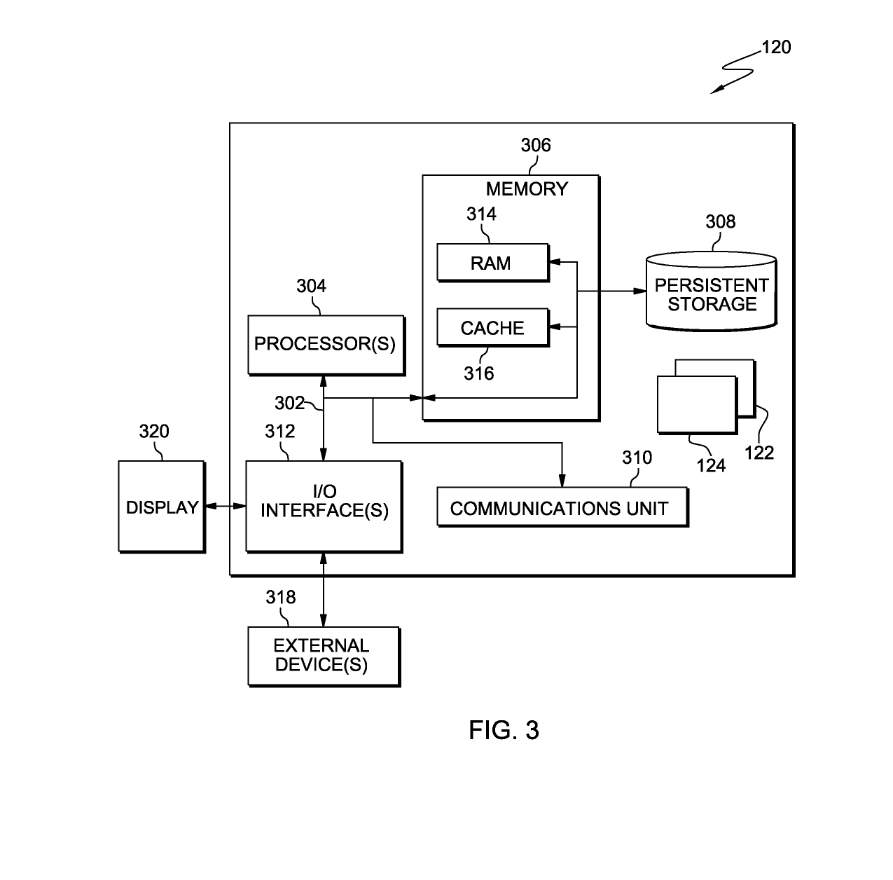

Mobile computing device 120 includes recommending program 122 and user database 124. Mobile computing device 120 can be a laptop computer, a tablet computer, a netbook computer, a personal digital assistant (PDA), a personal computer (PC), a smart phone, or any programmable electronic mobile device capable of communicating with server computing device 130. In an exemplary embodiment of the present invention, mobile computing device 120 can be a PDA, a smart phone, or other mobile cellular phone capable of downloading applications and data via network 110. Mobile computing device 120 may include internal and external hardware components, as depicted and described in further detail with respect to FIG. 3.

Recommending program 122 collects environmental factors and information of a mobile computing device, for example, orientation of the device, location of the device, lighting detected by the device, current time, direction and/or velocity of the device, and sounds or noises detected by the device. Recommending program 122 collects historical information for the mobile computing device, including mobile applications (“applications”) a user activates under the same or similar environment conditions or factors, and historical information across a network of users, such as applications other users activate and use in similar circumstances and conditions. Recommending program 122 uses the historical information, along with the environment information, to recommend an application that may be of use to the user of the mobile computing device. User database 124 stores applications downloaded to the mobile computing device and stores the historical information for the mobile computing device recommending program 122 collects.

Server computing device 130 can be a laptop computer, a tablet computer, a netbook computer, a PC, a PDA, a smart phone, or any programmable electronic device capable of communicating with mobile computing device 120 and with various other components and devices within distributed data processing environment 100 via network 110. Network user database 134 stores historical information for users connected to network 110, including what applications are used in certain environment factors, situations or circumstances.

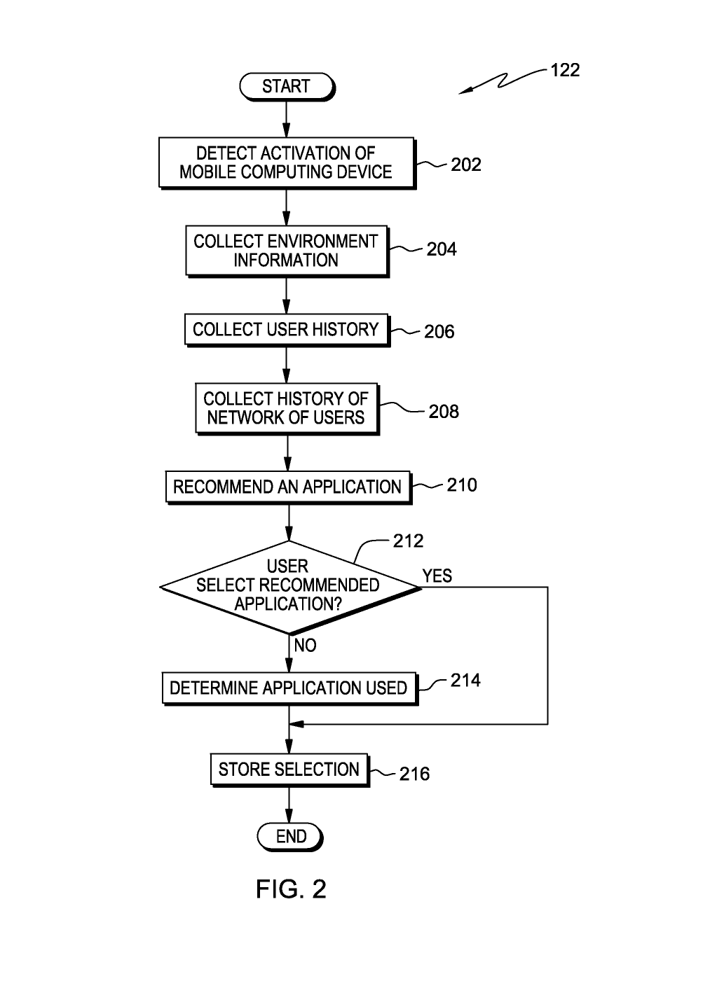

FIG. 2 is a flowchart depicting operational steps of recommending program 122 for collecting environmental and historical information for a mobile computing device and recommending an application based on the collected information, in accordance with an embodiment of the present invention.

Recommending program 122 detects activation of a mobile computing device, such as mobile computing device 120 (step 202). Activating mobile computing device 120 may include turning the mobile computing device on, unlocking the mobile computing device using a password, or changing the orientation of the mobile computing device.

Recommending program 122 collects environment information of the mobile computing device (step 204). Environment information can include a variety of information, including, for example, a location of the mobile computing device, a time, including date, season, day or night, or proximity indicators of people or devices within a certain proximity. Environment information may also include an orientation of the mobile computing device, such as vertical or horizontal, a facing direction, or a velocity or direction of travel of the mobile computing device. Collected environment information may include audio information, such as a type of music, volume, voices, or machinery, or visual information, such as brightness, image detection, or identifying a user of the mobile computing device. Additional environmental factors may include weather conditions, such as a temperature, a forecast, precipitation, pollen levels, wind, or clouds. Environment information may also include recently launched applications, or other factors, conditions, circumstances, or influences surrounding and/or detectable by the mobile computing device.

Recommending program 122 collects user history for the mobile computing device (step 206). User history can be stored in user database 124 of mobile computing device 120. User history includes information and associations between applications the user has previously used when a certain combination of environment factors, circumstances or conditions are present. For example, when environment factors are present such as a user is approaching home, it is a weekday, approximately 5:30 pm, and snow is forecast, the user typically launches a garage door opener application.

Recommending program 122 collects history of a network of users (step 208). Historical usage for a network of users, e.g., other users of mobile computing devices communicating via network 110, can be stored in network user database 132. Recommending program 122 collects historical usage information for a certain combination of environment factors to determine what applications are used by other users. For example, when environment factors such as loud, live music playing and crowd cheering, for over two hours are present, other users launch a lighter application.

Recommending program 122 recommends an application (step 210). Recommending program 122 displays the recommended application on the mobile computing device, and can display only the recommended application to the user, or the recommending program can display a list of applications ranked according to relevance to a user. An application can be email, camera, calendar, games, weather, GPS, magazines, or any other software application designed to run on smart phones, tablet computers, and other mobile computing devices, and includes applications that are free or are purchased and downloaded from an application distribution platform, such as the Apple App Store^{SM}. For example, recommending program 122 collects environment factors for the mobile computing device including low light and night time. Recommending program 122 may recommend a flashlight application to a user.

In various embodiments of the present invention, collected environmental information is correlated to usage of certain applications, and for each environment factor and each application, a ranking is developed that indicates an association of the environment factor with the application. Recommending program 122 looks for a combination of environment factors to determine an application used most under the combination of factors. The more factors present when a specific application is used, the more relevant the application will be when the factors are present again. Recommending program 122 recommends an application when, for the collected environment factors, one application ranks higher, or is more relevant, than another application.

In an exemplary embodiment of the present invention, a user has applications to operate a television remote control, a DVR remote control, and heating and cooling of the home. Each device is always used at the same location, but each is activated with other varying factors, such as orientation of the device, weather, proximity of people, or time. For example, the television remote is operated a majority of the time when the mobile computing device is lying flat and pointed at the television. The DVR remote is normally used under the same environment factors as the television remote, except the plane of the mobile computing device is pointed at an angle 20 degrees lower. A heating and cooling application is typically used when a change in weather is forecast and the mobile computing device is pointed to the right of the television and slightly angled upward (e.g., 15 degrees). Using the above example, when the user lays the mobile computing device flat and points it at the television, recommending program 122 recommends first the television remote application, then DVR remote application, and heating and cooling application. However, when the user changes the angle to be slightly lower (e.g., pointed below the television at the DVR), the order of recommended applications changes to first DVR remote application, television remote application and then heating and cooling application.

Recommending program 122 determines whether a user selects the recommended application (decision block 212). A user of mobile computing device 120 may select the recommend application by touching the application icon on a touch screen, using a voice command to launch the application, responding to a prompt displayed on the mobile computing device or audio emitted from the mobile computing device, or selecting any other means available to activate the recommended application or to opt not to activate the recommended application. If a user has selected the recommended application (decision block 212, “yes” branch), recommending program 122 stores the selection (step 216). The selection is stored in user database 124 as historical information, specifically, as an example of an application appropriate for a user under the environment factors present.

If a user has not selected the recommended application (decision block 212, “no” branch), recommending program 122 determines what application was used instead (step 214) and stores the selection (step 216). A user may opt not to use the recommended application and instead choose another application, either from a list of applications recommending program 122 presents or from another menu, or choose not to activate an application. Recommending program 122 stores the user selection, or lack of selection, in user database 124 and associates the selection with the environment factors present.

FIG. 3 depicts a block diagram of components of mobile computing device 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Mobile computing device 120 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Recommending program 122 and user database 124 can be stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including server computing device 130. In these examples, communications unit 310 includes one or more network interface cards. Communications unit 310 may provide communications through the use of either or both physical and wireless communications links. Recommending program 122 and user database 124 may be downloaded to persistent storage 308 through communications unit 310.

I/O interface(s) 312 allows for input and output of data with other devices that may be connected to mobile computing device 120. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., recommending program 122 and user database 124, can be stored on such portable computer-readable storage media and can be loaded onto persistent storage 308 via I/O interface(s) 312. I/O interface(s) 312 also connect to a display 320. Display 320 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for displaying an application for use on a mobile computing device, the method comprising:
determining, by one or more computer processors, one or more environmental factors for a current environment of a mobile computing device;
determining, by the one or more computer processors, based, at least in part, on the one or more environmental factors and past usage information of the mobile computing device, an application for use with the mobile computing device; and
displaying the application on the mobile computing device.

2. The method of claim 1, wherein the one or more environmental factors includes at least one of: an orientation of the mobile computing device, a facing direction of the mobile computing device, movement of the mobile computing device, location of the mobile computing device, audio factors, visual factors, brightness, weather, time, proximity to other mobile computing devices and recently used applications.

3. The method of claim 1, wherein the past usage information of the mobile computing device at least includes applications stored on the mobile computing device and associations between applications used when at least one of one or more environment factors was present.

4. The method of claim 1, further comprising:
determining, by the one or more computer processors, whether the displayed application is used with the mobile computing device; and
responsive to determining the displayed application is used with the mobile computing device, storing the displayed application as associated with the one or more environmental factors.

5. The method of claim 1, further comprising:
receiving historical usage information for a plurality of mobile computing devices communicating through a network, wherein the historical usage information includes one or more applications used by other mobile computing devices in association with the one or more environmental factors;
determining, by the one or more computer processors, based on the one or more environmental factors, the past usage information for the mobile computing device and the received historical usage information, an application for use with the mobile computing device; and
displaying the application on the mobile computing device.

6. The method of claim 1, wherein the step of displaying the application on the mobile computing device further comprises:
determining, by the one or more computer processors, at least one other application for use with the mobile computing device, based, at least in part, on the one or more environmental factors; and
displaying a list of applications on the mobile computing device, wherein the list contains the determined application and the at least one other application.

7. The method of claim 1, wherein the application is a mobile software application.

8. A computer program product for displaying an application for use on a mobile computing device, the computer program product comprising:
one or more computer-readable tangible storage media and program instructions stored on the one or more computer-readable tangible storage media, the program instructions comprising:
program instructions to determine determining one or more environmental factors for a current environment of a mobile computing device;
program instructions to determine based, at least in part, on the one or more environmental factors and past usage information of the mobile computing device, an application for use with the mobile computing device; and
program instructions to display the application on the mobile computing device.

9. The computer program product of claim 8, wherein the one or more environmental factors includes at least one of: an orientation of the mobile computing device, a facing direction of the mobile computing device, movement of the mobile computing device, location of the mobile computing device, audio factors, visual factors, brightness, weather, time, proximity to other mobile computing devices and recently used applications.

10. The computer program product of claim 8, wherein the past usage information of the mobile computing device at least includes applications stored on the mobile computing device and associations between applications used when at least one of one or more environment factors was present.

11. The computer program product of claim 8, further comprising:
program instructions to determine whether the displayed application is used with the mobile computing device; and
responsive to determining the displayed application is used with the mobile computing device, program instructions to store the displayed application as associated with the one or more environmental factors.

12. The computer program product of claim 8, further comprising:
program instructions to receive historical usage information for a plurality of mobile computing devices communicating through a network, wherein the historical usage information includes one or more applications used by other mobile computing devices in association with the one or more environmental factors;
program instructions to determine based on the one or more environmental factors, the past usage information for the mobile computing device and the received historical usage information, an application for use with the mobile computing device; and
program instructions to display the application on the mobile computing device.

13. The computer program product of claim 8, wherein the program instructions to display the application on the mobile computing device further comprise:
program instructions to determine at least one other application for use with the mobile computing device, based, at least in part, on the one or more environmental factors; and
program instructions to display a list of applications on the mobile computing device, wherein the list contains the determined application and the at least one other application.

14. A computer system for displaying an application for use on a mobile computing device, the computer system comprising:
one or more computer processors;
one or more computer-readable tangible storage media;
program instructions stored on the one or more computer-readable tangible storage media for execution by at least one of the one or more computer processors, the program instructions comprising:
program instructions to determine determining one or more environmental factors for a current environment of a mobile computing device;
program instructions to determine based, at least in part, on the one or more environmental factors and past usage information of the mobile computing device, an application for use with the mobile computing device; and
program instructions to display the application on the mobile computing device.

15. The computer system of claim 14, wherein the one or more environmental factors includes at least one of: an orientation of the mobile computing device, a facing direction of the mobile computing device, movement of the mobile computing device, location of the mobile computing device, audio factors, visual factors, brightness, weather, time, proximity to other mobile computing devices and recently used applications.

16. The computer system of claim 14, wherein the past usage information of the mobile computing device at least includes applications stored on the mobile computing device and associations between applications used when at least one of one or more environment factors was present.

17. The computer system of claim 14, further comprising:
program instructions to determine whether the displayed application is used with the mobile computing device; and
responsive to determining the displayed application is used with the mobile computing device, program instructions to store the displayed application as associated with the one or more environmental factors.

18. The computer system of claim 14, further comprising:
program instructions to receive historical usage information for a plurality of mobile computing devices communicating through a network, wherein the historical usage information includes one or more applications used by other mobile computing devices in association with the one or more environmental factors;
program instructions to determine based on the one or more environmental factors, the past usage information for the mobile computing device and the received historical usage information, an application for use with the mobile computing device; and
program instructions to display the application on the mobile computing device.

19. The computer system of claim 14, wherein the program instructions to display the application on the mobile computing device further comprise:
program instructions to determine at least one other application for use with the mobile computing device, based, at least in part, on the one or more environmental factors; and
program instructions to display a list of applications on the mobile computing device, wherein the list contains the determined application and the at least one other application.

20. The computer system of claim 14, wherein the application is a mobile software application.
